(19) United States
(12) Patent Application Publication
(10) Pub. No.: US 2016/0052020 A1
(43) Pub. Date: Feb. 25, 2016

(54) PIEZOELECTRIC DEVICE AND ELECTRONIC DEVICE INCLUDING THE SAME

(71) Applicant: INNOCHIPS TECHNOLOGY CO., LTD., Ansan-Si (KR)

(72) Inventors: In Kil PARK, Seongnam-Si (KR); Tae Hyung NOH, Siheung-Si (KR); Sung Cheol PARK, Ansan-Si (KR); Young Sul KIM, Seoul (KR); Kyung Seob YOON, Suwon-Si (KR); Hee Seob SHIN, Siheung-Si (KR); In Seob JUNG, Ansan-Si (KR)

(21) Appl. No.: 14/710,581

(22) Filed: May 12, 2015

(30) Foreign Application Priority Data
Aug. 19, 2014 (KR) 10-2014-0107857

(51) Int. Cl. B06B 1/06

(52) U.S. Cl. CPC B06B 1/0607; B06B 1/0603

(57) ABSTRACT

Provided is a piezoelectric device including a first piezoelectric plate, a vibration plate provided to contact one surface of the first piezoelectric plate, and at least one second piezoelectric plate provided to contact the vibration plate, wherein the first and second piezoelectric plates have different resonant frequencies.

### CROSS-REFERENCE TO RELATED APPLICATION

This application claims priority to Korean Patent Application No. 2014-0107857 filed on Aug. 19, 2014 and all the benefits accruing therefrom under 35 U.S.C. §119, the contents of which are incorporated by reference in their entirety.

### BACKGROUND

The present disclosure relates to a piezoelectric device, and more particularly, to a piezoelectric device usable as a piezoelectric acoustic device and piezoelectric vibration device and an electronic device including the same.

A wireless call function itself such as voice or message transmission and reception is a main purpose in a typical mobile terminal However, as recently a smart phone is developed, the wireless call function is merely a simple function and performances of various functions such as internet, applications, TV, navigation, and SNS become the main purpose.

Accordingly, in order to conveniently use various functions of a smart phone, a display unit of a smart phone is enlarged, the size thereof gets large, and technology rapidly developed including internet speed, operation, or pupil recognition allows a user to more conveniently use a smart phone terminal. In addition, in the market, a smart phone terminal to which various functions are added is rapidly released with fierce competition between companies.

However, as the display is enlarged and accordingly the size of the smart phone terminal gets larger in order to realize various functions of a smart phone, when wearing casual dress for taking a walk or exercising, it is inconvenient to carry or a robbery or loss case may occur. In addition, when possessing the smart phone in a bag, it is inconvenient to take the smart phone out of the bag for an incoming or outgoing call, or using a messaging function. There is also a limitation in that vibration or a ring tone of the smart phone in the bag is not heard by a user to allow the user not to receive an incoming call or message.

In order to solve that limitation, a technique enabling to be mounted on a human body, namely wearable technique is being developed. As a typical example, Korean Patent Application Laid-open Publication Nos. 10-2009-0046306 and 10-2012-0083804 respectively disclose “A band type mobile terminal” and “Mobile terminal modifiable to bracelet type”. In addition, Korean Patent Application Laid-open Publication No. 10-2013-0054309 also discloses “Human body-mounted auxiliary mobile device assembly”. Such typical techniques enable the wearable device, namely, an auxiliary mobile device to be carried in a watch, or necklace type.

The auxiliary mobile device notifies a user of message reception with a notifying sound or vibration. To this end, a speaker for generating the notifying sound or an actuator for generating vibration is required to be mounted in the auxiliary mobile device. In other words, both the speaker and actuator are required to be mounted in the auxiliary mobile device. However, since the speaker and actuator are all mounted, areas occupied by them in the auxiliary device become large and accordingly there is a limitation in making the size of the auxiliary mobile device small.

### SUMMARY

The present disclosure provides a piezoelectric device usable as at least any one of a piezoelectric sound device and piezoelectric vibration device.

The present disclosure also provides a piezoelectric device capable of generating a sound and vibration by being mounted in an electronic device and operated as at least any one of the piezoelectric sound device and piezoelectric vibration device according to an applied signal.

The present disclosure also provides an electronic device including a piezoelectric device available as at least any one of the piezoelectric sound device and piezoelectric vibration device mounted therein to reduce an area occupied by the piezoelectric device.

In accordance with an exemplary embodiment, a piezoelectric device includes: a first piezoelectric plate; a vibration plate provided to contact one surface of the first piezoelectric plate; and at least one second piezoelectric plate provided to contact the vibration plate, wherein the first and second piezoelectric plates have different resonant frequencies.

The first piezoelectric plate may be provided in a frame shape of which a central portion is vacant.

The vibration plate may be provided on one surface of the first piezoelectric plate and the second piezoelectric plate may be provided at an area inside the first piezoelectric plate on the vibration plate.

The second piezoelectric plate may overlap at least one area of the first piezoelectric plate to be provided at the area inside the first piezoelectric plate.

The piezoelectric device may further include a base provided on another surface of the first piezoelectric plate.

The base may be provided in a frame shape of which a central area is vacant and the first piezoelectric plate is provided on at least one area of the base.

The second piezoelectric plate may be provided on an area inside the base.

The piezoelectric device may further include a base provided on another surface of the vibration plate.

The base may be provided in a frame shape of which a central area is vacant and the vibration plate is provided on the base.

The first piezoelectric plate may be provided to overlap at least a part of the base and the at least one second piezoelectric plate is provided at an area inside the first piezoelectric plate.

The piezoelectric device may further include a load provided at least one area of the first and second piezoelectric plates.

At least any one of the first and second piezoelectric plates may operate as a piezoelectric vibration device and at least another operates as a piezoelectric sound device.

In accordance with another exemplary embodiment, an electronic device includes: a piezoelectric device including a first piezoelectric plate, a vibration plate provided to contact the first piezoelectric plate, and at least one second piezoelectric plate provided on the vibration plate, wherein the first and second piezoelectric plates have different resonant frequencies, wherein at least any one of the first and second piezoelectric plates operates as a piezoelectric vibration device and at least another operates as a piezoelectric sound device.

The electronic device is separated from a mobile terminal body to perform an auxiliary function of the mobile terminal, and is wearable.

The first piezoelectric plate may be provided in a frame shape and the second piezoelectric plate may be provided to overlap at least one area of the first piezoelectric plate at an area inside the first piezoelectric plate.

The electronic device may further include a base provided on another surface of the first piezoelectric plate or the vibration plate and having a frame shape of which a central area is vacant.

The electronic device may further include a load provided on at least one area on the first and second piezoelectric plates.

### BRIEF DESCRIPTION OF THE DRAWINGS

Exemplary embodiments can be understood in more detail from the following description taken in conjunction with the accompanying drawings, in which:

FIGS. 1 to 3 are a plan view, a cross-sectional view, and an exploded perspective view of a piezoelectric device according to an exemplary embodiment;

FIGS. 4 and 5 are graphs representing sound pressure and vibration characteristics of a piezoelectric device according to an embodiment;

FIGS. 6 to 7 are a plan view and a cross-sectional view of a piezoelectric device according to another exemplary embodiment;

FIGS. 8 to 9 are cross-sectional views of piezoelectric devices according still other exemplary embodiments; and

FIGS. 10A to 12E are plan views of piezoelectric devices according to various modification examples of an embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

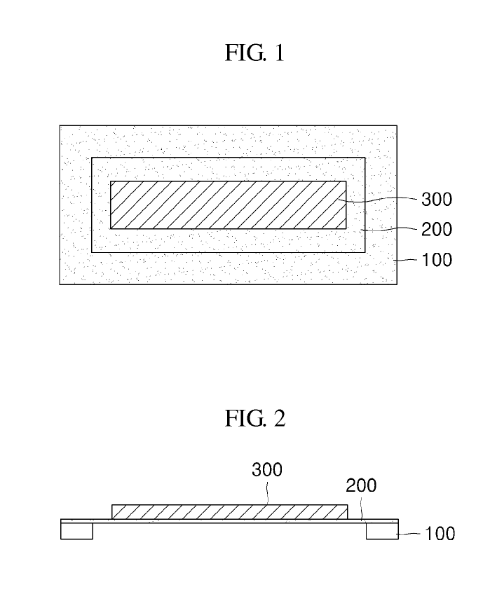

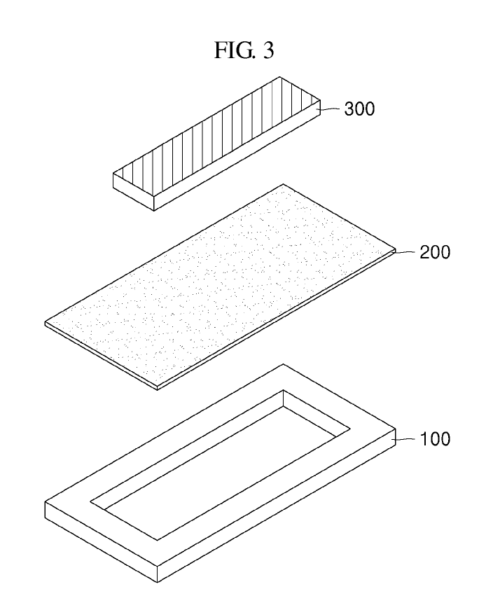

FIG. 1 is a plan view of a piezoelectric device according to an embodiment, FIG. 2 is a cross-sectional view, and FIG. 3 is an explosive perspective view.

Referring to FIGS. 1 to 3, a piezoelectric device according to an embodiment may include a first piezoelectric plate 100, a vibration plate 200 provided on the first piezoelectric plate 100, and a second piezoelectric plate 300 provided on the vibration plate 200. Here, the first and second piezoelectric plates 100 and 300 may be provided in different shapes and have different resonant frequencies.

The first piezoelectric plate 100 is provided to have an approximately rectangular frame having a predetermined width and vacant inner part. The first piezoelectric plate 100 may be provided in various forms such as a square, circle, ellipse, or polygon as well as the rectangular frame form. The first piezoelectric plate 100 may include a substrate and a piezoelectric layer in which the substrate is formed on at least one surface thereof. For example, the first piezoelectric plate 100 may be formed in a bimorph type in which piezoelectric layers are formed on both sides of a substrate, or in a unimorph type in which a piezoelectric layer is formed on one side of a substrate. The piezoelectric layer may be formed by stacking at least one layer, or a plurality of layers. In addition, electrodes may be respectively formed on the top and bottom portions of the piezoelectric layer. In other words, a plurality of piezoelectric layers and a plurality of electrodes may be alternately stacked to realize the first piezoelectric plate 100. Here, the piezoelectric layer may be formed by a piezoelectric material, for example, PZT (Pb, Zr, Ti), NKN (Na, K, Nb), or BNT (Bi, Na, Ti)-based material. In addition, the piezoelectric layers may be polarized in different directions or an identical direction to be stacked. In other words, when a plurality of piezoelectric layers are formed on one surface of the substrate, polarization of each of the plurality of piezoelectric layers may be alternately formed in different directions or in an identical direction. Furthermore, the substrate may use a material having a characteristic that vibration may be generated while a structure in which the piezoelectric layers are stacked may be maintained, for example, a metal or plastics. However, the second piezoelectric plate 100 may not employ a substrate of a different material from the piezoelectric layer. In other words, the second piezoelectric plate 100 may provide an unpolarized piezoelectric layer at the central portion and a plurality of piezoelectric layers polarized in different directions may be stacked at the top and bottom portions thereof. Furthermore, an electrode pattern (not illustrated) to which a driving signal is applied may be formed on at least one area of the first piezoelectric plate 100. For example, the electrode pattern may be provided at an edge of the top or bottom surface of the first piezoelectric plate 100. At least two electrode patterns may be formed separately from each other and connected to an electronic device, for example, an auxiliary mobile device through connection to connection terminals (not illustrated). The first piezoelectric plate 100 may be driven as a piezoelectric sound device or a piezoelectric vibration device according to a signal applied through an electronic device, namely, an AC power.

The vibration plate 200 is provided on the first piezoelectric plate 100 having a frame shape. In other words, the vibration plate 200 is provided in an approximately rectangular form, and the edges thereof are bonded to the top portion of the first piezoelectric plate 100. The vibration plate 200 may use a material including a metal, silicon, a polymer, or pulp. For example, the vibration plate 200 may use a resin film, and also use a material including ethylene-propylene rubber-based or styrene butadiene rubber-based material having a Young's modulus of approximately 1 MPa to approximately 10 GPa and a large loss factor. The vibration plate 200 is provided to have a size smaller than or equal to that of the first piezoelectric plate 100 and greater than that of the second piezoelectric plate 300. The second piezoelectric plate 300 is bonded to the top surface of such a vibration plate 200. In addition, the vibration plate 200 has an adhesive tape (not illustrated) provided thereon and the second piezoelectric plate 300 is bonded to the vibration plate 200 with the adhesive tape. Such an adhesive tape may use a rubber-based, acryl-based, or silicon-based adhesive material. Furthermore, the adhesive tape may have an identical form and size to those of the vibration plate 200 or the second piezoelectric plate 300.

The second piezoelectric plate 300 is provided on the vibration plate 200 and has a different shape from that of the first piezoelectric plate 100. For example, the second piezoelectric plate 300 may be provided in an approximately rectangular shape having a predetermined width and length on the vibration plate 200 in a space inside the first piezoelectric plate 100 having a frame shape. Here, the thickness of the second piezoelectric plate 300 may be the same as or different from that of the first piezoelectric plate 100. For example, the second piezoelectric plate 300 may have the thickness thinner than or equal to that of the first piezoelectric plate 100. Such a second piezoelectric plate 300 may include a substrate and a piezoelectric layer formed at least one surface of the substrate. In other words, the second piezoelectric plate 300 may be provided in an identical stack structure to that of the first piezoelectric plate 100. For example, the second piezoelectric plate 300 may be formed in a bimorph type in which piezoelectric layers are formed on both sides of the substrate, or in a unimorph type in which a piezoelectric layer is formed on one side of the substrate. The piezoelectric layer may be formed by stacking at least one layer, or a plurality of layers. In addition, electrodes may be respectively formed on the top and bottom portions of the piezoelectric layer. In other words, a plurality of piezoelectric layers and a plurality of electrodes may be stacked to realize the second piezoelectric plate 300. In addition, the piezoelectric layers may be polarized in different directions or an identical direction to be stacked. In other words, when a plurality of piezoelectric layers are formed on one surface of the substrate, polarization of each of the plurality of piezoelectric layers may be alternately formed in different directions or in an identical direction. Furthermore, the substrate may use a material having a characteristic that vibration may be generated while a structure in which the piezoelectric layers are stacked may be maintained, for example, a metal or plastics. However, the second piezoelectric plate 300 may not employ a substrate of a different material from the piezoelectric layer. In other words, the second piezoelectric plate 300 may provide an unpolarized piezoelectric layer at the central portion and a plurality of piezoelectric layers polarized in different directions may be stacked at the top and bottom portions thereof. In addition, an adhesive (not illustrated) may be coated on at least one side surface of the second piezoelectric plate 300. For example, the adhesive may be coated on one side surface from one edge of the top surface of the second piezoelectric plate 300, or on all side surfaces from four edges of the top surface of the second piezoelectric plate 300. In addition, the adhesive (not illustrated) may be provided on at least a portion of at least one side surface of the second piezoelectric plate 300. In other words, the adhesive may be partially or entirely coated on the side surfaces of the second piezoelectric plate 300. The adhesive is a reinforcing agent for preventing dissection from occurring on the interfaces between the side surfaces of the second piezoelectric plate 300 and the adhesive tape. As the adhesive, it is better to use a polyurethane-based or silicon-based thermally curable adhesive having a low Young's modulus, which does not restrict displacement of the second piezoelectric plate 300. Furthermore, an electrode pattern (not illustrated) to which a driving signal is applied may be formed on at least one area of the first piezoelectric plate 300. At least two electrode patterns may be formed separately from each other and connected to an electronic device, for example, an auxiliary mobile device through connection to connection terminals (not illustrated). Such a second piezoelectric plate 300 may be driven as a piezoelectric sound device or a piezoelectric vibration device according to a signal applied through an electronic device, namely, an AC power.

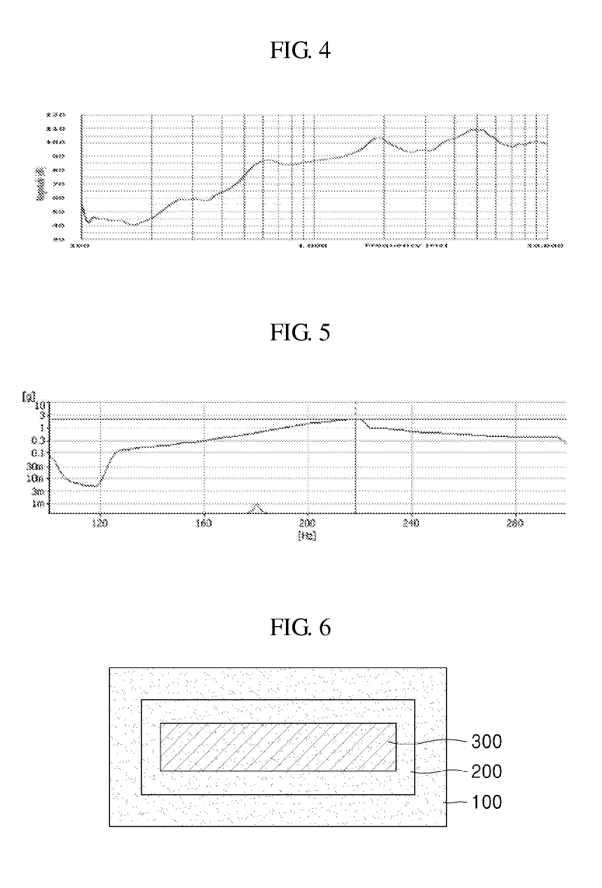

As described above, a piezoelectric device according to embodiments may include a first piezoelectric plate 100 in an approximately frame shape, a vibration plate 200 provided on the top portion of the first piezoelectric plate 100, and a second piezoelectric plate 300 provided on the vibration plate 200 and in a space inside the first piezoelectric plate 100. At this point, the first and second piezoelectric plates 100 and 300 may have different shapes and different resonant frequencies. Such a piezoelectric device may be provided in an electronic device, for example, a smart phone or in an auxiliary mobile device, namely, a wearable device mountable on a body, separated from the smart phone and performing an auxiliary function of the smart phone, and may operate as at least any one of a piezoelectric speaker and a piezoelectric actuator according to a signal provided from the electronic device. In other words, at least any one of the first and second piezoelectric plates 100 and 300 may operate as a piezoelectric vibration device and the other may operate as a piezoelectric sound device according to a signal input from the electronic device, or both the first and second piezoelectric plates 100 and 300 may operate as a piezoelectric sound device or a piezoelectric vibration device. In addition, the second piezoelectric plate 300 contacts the polymer-based or pulp-based vibration plate 200 to secondarily vibrate primary vibration of the vibration plate 200, which occurs by the piezoelectric plate 300, and amplify the vibration. Accordingly, sound pressure and an output of the piezoelectric sound device may be improved. In other words, as illustrated in FIG. 4, a piezoelectric device according to an embodiment represents sound pressure characteristic of the average of 87 dB when used as the piezoelectric sound device. In addition, as illustrated in FIG. 5, the piezoelectric device represents an output of approximately 2.1 G at a resonant frequency of 218 Hz. Accordingly, a piezoelectric device according to an embodiment is a complex device that the first and second piezoelectric plates 100 and 300 having different shapes and resonant frequencies are provided to include the vibration plate 200 therebetween and are applied to an electronic device, such as an auxiliary mobile device, to generate a sound and vibration.

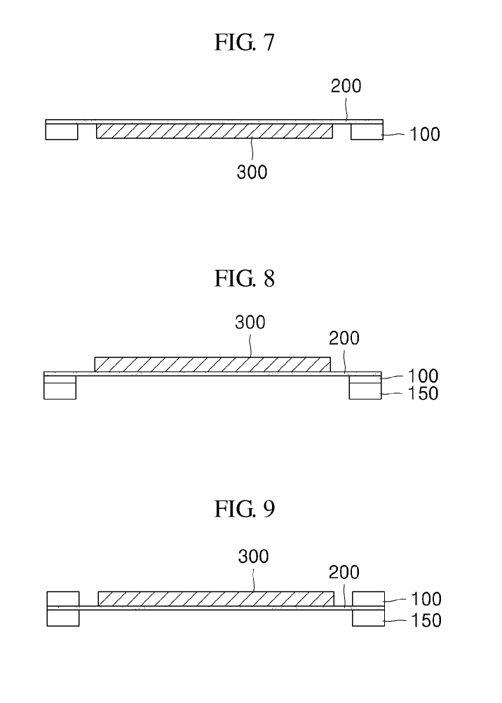

Furthermore, as illustrated in FIGS. 6 and 7, the vibration plate 200 may be provided on one surface of the first piezoelectric plate 100 having a frame shape, and the second piezoelectric plate 300 may be boned to the rear surface of the vibration plate 200 to be provided inside area of the first piezoelectric plate 100. In other words, in a piezoelectric device according to another embodiment, the vibration plate 200 is provided on one surface of the first piezoelectric plate 100 and the second piezoelectric plate 300 is provided on one surface of the vibration plate 200 contacting the first piezoelectric plate 100. Accordingly, the second piezoelectric plate 300 may be provided inside a space formed by the first piezoelectric plate 100. Compared to this, in a piezoelectric device according to an embodiment illustrated in FIGS. 1 to 3, the vibration plate 200 is provided on one surface of the first piezoelectric plate 100 and the second piezoelectric plate 300 is provided on the other surface of the vibration plate 200, which does not contact the first piezoelectric plate 100. Accordingly, a piezoelectric device according to another embodiment may have the reduced thickness compared to that according to the one embodiment.

In addition, the piezoelectric device according to an embodiment may have a base 150 provided in a bottom side of the first piezoelectric plate 100, as illustrated in FIG. 8.

The base 150 may be provided with a steel use stainless (SUS) material in an approximately rectangular frame shape. In other words, the base 150 may be include two opposite long axes having a predetermined width and two short axes provided therebetween and having a predetermined width. In addition, a first piezoelectric plate 100 may be provided on the top portion of the base 150 and bonded to the base 150 by using an adhesive or adhesive tape. At this point, the first piezoelectric plate 100 may be provided on all the long and short axes of the base 150, or only on the long axes or short axes. In addition, as illustrated in FIG. 9, a vibration plate 200 is provided on the base 150 and the first and second piezoelectric plates 100 and 300 may be provided to be separated by a predetermined interval on the vibration plate 200. At this point, the first piezoelectric plate 100 is provided in an identical shape to the base 150 to overlap the base 150, and the second piezoelectric plate 300 may be provided in an inner space of the first piezoelectric plate 100.

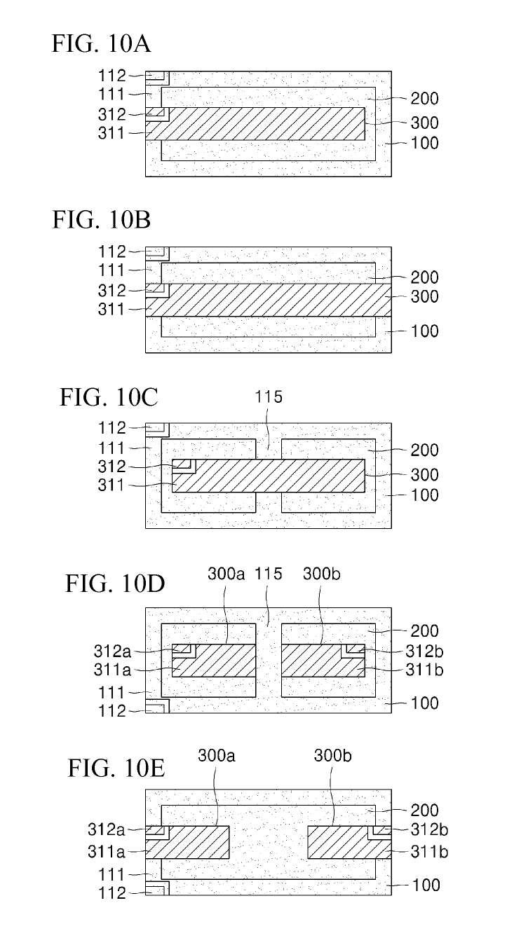

In addition, a piezoelectric device of an embodiment may be diversely changed in a shape and accordingly various frequency characteristics thereof can be obtained. FIGS. 10A to 10D illustrate piezoelectric devices according to various modification examples of an embodiment.

Referring to FIG. 10A, a piezoelectric device of an embodiment includes a first piezoelectric plate 100 provided in an approximately rectangular frame shape, a vibration plate 200 provided in an approximately rectangular plate shape to allow edges thereof to make contact on the first piezoelectric plate 100 by a predetermined width, and a second piezoelectric plate 300 provided on the vibration plate 200 to allow one area thereof to overlap the first piezoelectric plate 100. In other words, the second piezoelectric plate 300 may be provided in an approximately rectangular shape having a predetermined width and length and one short side thereof overlaps one area of the first piezoelectric plate 100 by a predetermined width. In addition, at least two electrode patterns 111 and 112 are formed on the top surface of the first piezoelectric plate 100 and at least two electrode patterns 311 and 312 are formed on the top surface of the second piezoelectric plate 300. AC power having different polarities may be applied to the electrode patterns 111 and 112 of the first piezoelectric plate 100 and AC power having different polarities may also be applied to the electrode patterns 311 and 312 of the second piezoelectric plate 300. At this point, a vibration signal is applied to the electrode patterns 111 and 112 of the first piezoelectric plate 100 and a sound signal is applied to the electrode patterns 311 and 312 of the second piezoelectric plate 300.

Referring to FIG. 10B, a piezoelectric device of an embodiment includes a first piezoelectric plate 100 provided in an approximately rectangular frame shape, a vibration plate 200 provided in an approximately rectangular plate shape to allow edges thereof to make contact on the first piezoelectric plate 100 by a predetermined width, and a second piezoelectric plate 300 provided on the vibration plate 200 to allow one area and the other area opposite to each other to overlap the first piezoelectric plate 100. In other words, the second piezoelectric plate 300 may be provided in an approximately rectangular shape having a predetermined width and length and one short side and the other short side thereof overlap two opposite areas of the first piezoelectric plate 100 by a predetermined width. In addition, at least two electrode patterns 111 and 112 are formed on the top surface of the first piezoelectric plate 100 to receive AC power according to a vibration signal and at least two electrode patterns 311 and 312 are formed on the top surface of the second piezoelectric plate 300 to receive AC power according to a sound signal.

Referring to FIG. 10C, a piezoelectric device of an embodiment includes a first piezoelectric plate 100 having an approximately rectangular frame shape, a dummy plate 115 provided between predetermined areas of two opposite long sides of the first piezoelectric plate 100, a vibration plate 200 provided in an approximately rectangular plate shape and edges thereof make contact on the first piezoelectric plate 100 by a predetermined width, and a second piezoelectric plate 300 of which the central portion overlaps the dummy plate 115 to be provided in a long side direction of the first piezoelectric plate 100. The dummy plate 115 may be formed to have a predetermined width between, for example, central portions of two opposite long sides. In addition, the dummy plate 115 may be formed in an identical stack structure to that of the first piezoelectric plate 100 to vibrate according to an applied voltage. However, the dummy plate 115 may not be polarized and may not vibrate. Here, the dummy plate 115 may be formed to have an identical width to, or be wider or narrower than that of the first piezoelectric plate 100. In addition, the central portion of the second piezoelectric plate 300 may overlap the dummy plate 115 to contact the dummy plate 115. In other words, the second piezoelectric plate 300 may allow the central portion thereof to overlap the dummy plate 115 to make contact on the vibration plate 200 and may be provided in an area in the first piezoelectric plate 110 in a long side direction of the first piezoelectric plate 100. Furthermore, the central portion of the extension plate 200 may contact the dummy plate 115. In other words, edges of the vibration plate 200 are boned to the first piezoelectric plate 100 by a predetermined width and the central portion thereof may be boned to the dummy plate 115. In addition, at least two electrode patterns 111 and 112 are formed on the top surface of the first piezoelectric plate 100 to receive a vibration signal and at least two electrode patterns 311 and 312 are formed on the top surface of the second piezoelectric plate 300 to receive a sound signal.

Referring to FIG. 10D, a piezoelectric device of an embodiment includes a first piezoelectric plate 100 having an approximately rectangular frame shape, a dummy plate 115 provided between predetermined areas, for example, the central portions of two opposite long sides of the first piezoelectric plate 100, a vibration plate 200 provided in an approximately rectangular plate shape to make contact on the first piezoelectric plate 100 by a predetermined width, and 2a and 2b piezoelectric plates 300a and 300b provided in opposite directions from the dummy plate 115. In other words, the 2a and 2b piezoelectric plates 300a and 320b may contact two side surfaces or the top surface of the dummy plate 115 to be respectively formed in a long side direction of the first piezoelectric plate 100. In addition, at least two electrode patterns 311 a and 312a may be formed on the top surface of the 2a piezoelectric plate 300a and at least two electrode patterns 311b and 312b may also be formed on the top surface of the 2b piezoelectric plate 300b. Signals having an identical polarity are applied to the electrode patterns 311a and 311b and signals having an opposite polarity to the signals applied to the electrode patterns 311a and 311b are applied to the electrode patterns 311b and 312b at the same time. However, sound signals are applied to these electrode patterns 311a, 311b, 312a, and 312b. In addition, at least two electrode patterns 111 and 112 may be formed on the top surface of the first piezoelectric plate 110 and AC power having different polarities according to a vibration signal may be applied thereto.

Referring to FIG. 10E, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and 2a and 2b piezoelectric plates 300a and 300b formed to make contact on the vibration plate 200 and to extend along a long side direction of the first piezoelectric plate 100 from two opposite short sides of the first piezoelectric plate 100. In other words, the 2a and 2b piezoelectric plates 300a and 120b are formed to overlap the top or side surfaces of two opposite short sides of the first piezoelectric plate 100 in a long side direction of the first piezoelectric plate 100 and are provided to be separated by a predetermined interval at the central area in the first piezoelectric plate 100. In addition, at least two electrode patterns 311a and 312a may be formed on the top surface of the 2a piezoelectric plate 300a and at least two electrode patterns 311b and 312b may also be formed on the top surface of the 2b piezoelectric plate 300b. These electrode patterns may be formed at areas overlapped with the first piezoelectric plate 100. AC power having different polarities according to a sound signal may be applied to each of the electrode patterns. In addition, at least two electrode patterns 111 and 112 may be formed on the top surface of the first piezoelectric plate 110 and AC power having different polarities according to a vibration signal may be applied thereto.

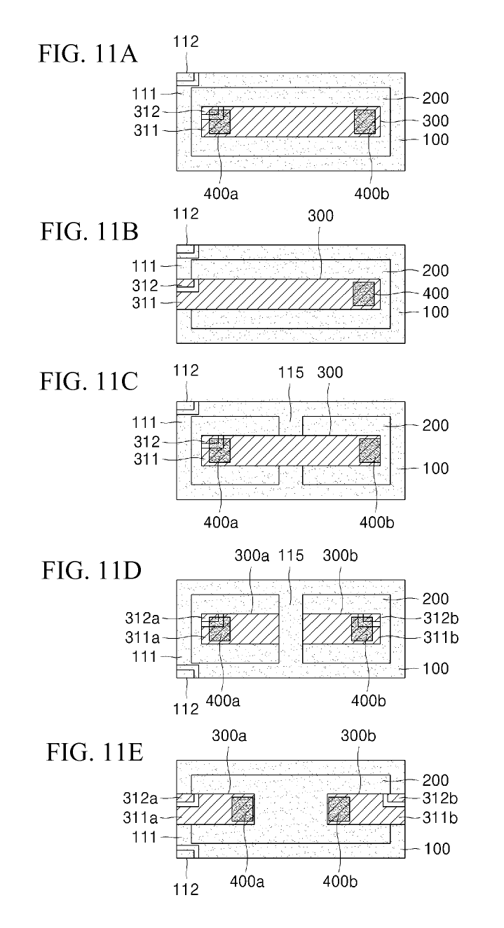

In addition, a piezoelectric device of an embodiment has a load provided on at least one area to increase a vibration force and accordingly frequency characteristic may be diversely changed. A weight, position, and form of the load may be diversely modified and accordingly various vibration forces may be realized. In addition, at least one load may be provided on at least one area of the second piezoelectric plate 300. For example, at least one load may be provided between one and the other short sides, for example, at the central portion of the second piezoelectric plate 300. FIGS. 11A to 11D illustrate piezoelectric devices according to various modification examples of an embodiment.

Referring to FIG. 11A, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and a second piezoelectric plate 300 provided on the vibration plate 200 in a space formed by long and short sides of the first piezoelectric plate 100, and loads 400a and 400b may be provided on end portions of the second piezoelectric plate 300. At this point, a load may be provided at the central portion in addition to the end portions and at least one load may be provided between one and the other end portions.

Referring to FIG. 11B, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and a second piezoelectric plate 300 provided to overlap a predetermined area of one short side of the first piezoelectric plate 100 and to make contact on the vibration plate 200 in a long side direction of the first piezoelectric plate 100. In addition, a load 400 may be provided on one end portion of the second piezoelectric plate 300, which does not overlap the first piezoelectric plate 100.

Referring to FIG. 11C, a piezoelectric device of an embodiment may include a first piezoelectric plate 100 having an approximately rectangular frame shape and having a dummy plate 115 formed between one long side and the other long side opposite to each other, a vibration plate 200 provided in an approximately rectangular plate shape to allow edges thereof to make contact on the first piezoelectric plate 100 by a predetermined width, and a second piezoelectric plate 300 provided to overlap the dummy plate 115 on the vibration plate 200 in a long side direction of the first piezoelectric plate 100. In addition, loads 400a and 400b may be provided on two opposite end portions of the second piezoelectric plate 300.

Referring to FIG. 11D, a piezoelectric device of an embodiment may include a first piezoelectric plate 100 having an approximately rectangular frame shape and having a dummy plate 115 formed between one long side and the other long side opposite to each other, a vibration plate 200 provided in an approximately rectangular plate shape to allow edges thereof to make contact on the first piezoelectric plate 100 by a predetermined width, and 2a and 2b piezoelectric plates 300a and 300b provided from two side surfaces of the dummy plate 115 on the vibration plate 200 in a long side direction of the first piezoelectric plate 100. Loads 400a and 400b may be provided on two opposite end portions of the 2a and 2b piezoelectric plates 300a and 300b, which do not contact the dummy plate 115. At this point, the loads 400a and 400b may be provided on the electrode patterns 311a, 312a, 311b, and 312b of the 2a and 2b piezoelectric plates 120a and 120b.

Referring to FIG. 10E, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and 2a and 2b piezoelectric plates 300a and 300b formed to overlap two opposite short sides of the first piezoelectric device 100 on the vibration plate 200 in a long side direction of the first piezoelectric plate 100 and to be separated from the central area in the first piezoelectric plate 100 by a predetermined interval. In addition, loads 400a and 400b are provided on end portions of the 2a and 2b piezoelectric plates 300a and 300b. In other words, the loads 400a and 400b may be provided at predetermined area of the 2a and 2b piezoelectric plates 300a and 300b, which do not overlap the first piezoelectric plate 100.

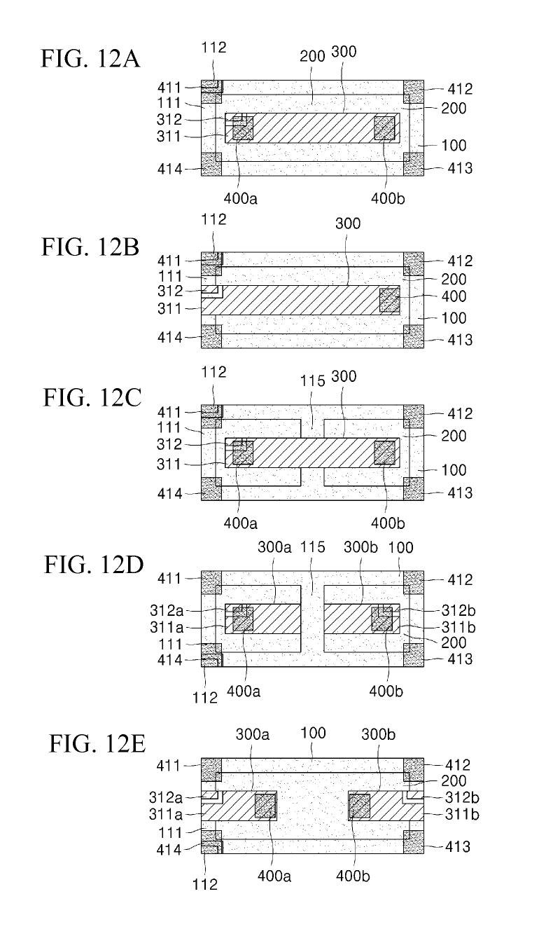

In addition, the load may be formed on a predetermined area of the first piezoelectric plate 100 in addition to the second piezoelectric plate 300, and FIGS. 12A to 12E illustrate piezoelectric devices on which loads are formed on the first and second piezoelectric plates 100 and 300.

Referring to FIG. 12A, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and a second piezoelectric plate 300 provided on the vibration plate 200 in a space formed by long and short sides of the first piezoelectric plate 100. In addition, loads 400a and 400b may be provided on end portions of the second piezoelectric plate 300, and a plurality of loads 411, 412, 413, and 414 may be provided at corner areas of the first piezoelectric plate 100.

Referring to FIG. 12B, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and a second piezoelectric plate 300 provided to overlap a predetermined area of one short side of the first piezoelectric plate 100 on the vibration plate 200 in a space of the first piezoelectric plate 100 in a long side direction of the first piezoelectric plate 100. In addition, a load 150 may be provided on one end portion of the second piezoelectric plate 300, which does not overlap the first piezoelectric plate 100, and a plurality of loads 151, 152, 153, and 154 may be provided on corner areas of the first piezoelectric plate 100.

Referring to FIG. 12C, a piezoelectric device of an embodiment may include a first piezoelectric plate 100 having an approximately rectangular frame shape and having a dummy plate 115 formed between one long side and the other long side thereof opposite to each other, a vibration plate 200 provided in an approximately rectangular plate shape to allow edges thereof to make contact on the first piezoelectric plate 100 by a predetermined width, and a second piezoelectric plate 300 provided to overlap the dummy plate 115 to make contact on the vibration plate 200 at an area inside the first piezoelectric plate 100 in a long side direction of the first piezoelectric plate 100. In addition, loads 400a and 400b may be provided on two end portions of the second piezoelectric plate 300, and a plurality of loads 411, 412, 413, and 414 may be provided at corner areas of the first piezoelectric plate 100.

Referring to FIG. 12D, a piezoelectric device of an embodiment may include a first piezoelectric plate 100 having an approximately rectangular frame shape and having a dummy plate 115 formed between one long side and the other long side thereof opposite to each other, a vibration plate 200 provided in an approximately rectangular plate shape to allow edges thereof to make contact on the first piezoelectric plate 100 by a predetermined width, and 2a and 2b piezoelectric plates 300a and 300b provided in a long side direction of the first piezoelectric plate 100 from two side surfaces of the dummy plate 115 at an area inside the first piezoelectric plate 100. In addition, loads 400a and 400b may be provided on end portions of the 2a and 2b piezoelectric plates 300a and 300b, and a plurality of loads 411, 412, 413, and 414 may be provided at corner areas of the first piezoelectric plate 100.

Referring to FIG. 10E, a piezoelectric device of an embodiment may include a first piezoelectric plate 100 having an approximately rectangular frame shape, a vibration plate 200 provided in an approximately rectangular plate shape to allow edges thereof to make contact on the first piezoelectric plate 100 by a predetermined width, and 2a and 2b piezoelectric plates 300a and 300b formed to overlap two opposite short sides of the first piezoelectric device 100 in a long side direction of the first piezoelectric plate 100 and to be separated from the central area in the first piezoelectric plate 100 by a predetermined interval. In addition, loads 400a and 400b are provided on end portions of the 2a and 2b piezoelectric plates 300a and 300b, and a plurality of loads 411, 412, 413, and 414 may be provided on corner areas of the first piezoelectric plate 100.

A piezoelectric device according to embodiments includes at least two piezoelectric plates having different resonant frequencies and a vibration plate disposed therebetween. The piezoelectric device according to embodiments is disposed in an electronic device such as an auxiliary mobile device to operate as at least any one of the piezoelectric sound device and piezoelectric vibration device according to a signal provided from the electronic device. In other words, at least one piezoelectric plate may operate as a piezoelectric vibration device, at least another piezoelectric plate may operate as a piezoelectric sound device, and at least two piezoelectric plates may simultaneously operate as the piezoelectric vibration device and piezoelectric sound device. Accordingly, an area occupied in the auxiliary mobile device can be reduced and accordingly the size and weight of the auxiliary mobile device can also be reduced by applying the piezoelectric device according to embodiments to the auxiliary mobile device, etc., in comparison to a typical technique that both the sound device and vibration device are applied. In addition, sound pressure and an output of at least one piezoelectric plate used as a piezoelectric sound device can be improved by applying a vibration plate.

Although the piezoelectric device and the electronic device including the same have been described with reference to the specific embodiments, they are not limited thereto. Therefore, it will be readily understood by those skilled in the art that various modifications and changes can be made thereto without departing from the spirit and scope of the present invention defined by the appended claims.

1. A piezoelectric device comprising:
a first piezoelectric plate;
a vibration plate provided to contact one surface of the first piezoelectric plate; and
at least one second piezoelectric plate provided to contact the vibration plate,
wherein the first and second piezoelectric plates have different resonant frequencies.

2. The piezoelectric device of claim 1, wherein the first piezoelectric plate is provided in a frame shape of which a central portion is vacant.

3. The piezoelectric device of claim 2, wherein the vibration plate is provided on one surface of the first piezoelectric plate and the second piezoelectric plate is provided at an area inside the first piezoelectric plate on the vibration plate.

4. The piezoelectric device of claim 3, wherein the second piezoelectric plate overlaps at least one area of the first piezoelectric plate to be provided at the area inside the first piezoelectric plate.

5. The piezoelectric device of claim 1, further comprising a base provided on another surface of the first piezoelectric plate.

6. The piezoelectric device of claim 5, wherein the base is provided in a frame shape of which a central area is vacant and the first piezoelectric plate is provided on at least one area of the base.

7. The piezoelectric device of claim 3, wherein the second piezoelectric plate is provided on an area inside the base.

8. The piezoelectric device of claim 1, further comprising a base provided on another surface of the vibration plate.

9. The piezoelectric device of claim 8, wherein the base is provided in a frame shape of which a central area is vacant and the vibration plate is provided on the base.

10. The piezoelectric device of claim 9, wherein the first piezoelectric plate is provided to overlap at least a part of the base and the at least one second piezoelectric plate is provided at an area inside the first piezoelectric plate.

11. The piezoelectric device of claim 2, further comprising a load provided at least one area of the first and second piezoelectric plates.

12. The piezoelectric device of claim 1, wherein at least any one of the first and second piezoelectric plates operates as a piezoelectric vibration device and at least another operates as a piezoelectric sound device.

13. An electronic device comprising:
a piezoelectric device comprising a first piezoelectric plate, a vibration plate provided to contact the first piezoelectric plate, and at least one second piezoelectric plate provided on the vibration plate, wherein the first and second piezoelectric plates have different resonant frequencies,
wherein at least any one of the first and second piezoelectric plates operates as a piezoelectric vibration device and at least another operates as a piezoelectric sound device.

14. The electronic device of claim 13, wherein the electronic device is separated from a mobile terminal body to perform an auxiliary function of the mobile terminal, and is wearable.

15. The electronic device of claim 13, wherein the first piezoelectric plate is provided in a frame shape and the second piezoelectric plate is provided to overlap at least one area of the first piezoelectric plate at an area inside the first piezoelectric plate.

16. The electronic device of claim 13, further comprising a base provided on another surface of the first piezoelectric plate or the vibration plate and having a frame shape of which a central area is vacant.

17. The electronic device of claim 13, further comprising a load provided on at least one area on the first and second piezoelectric plates.
